(19) United States
(12) Patent Application Publication
(10) Pub. No.: US 2007/0281722 A1
(43) Pub. Date: Dec. 6, 2007

(54) ONE-TO-MANY COMMUNICATION SERVICE USING COMPOSITE BROADCAST/MULTICAST FLOWS IN A WIRELESS NETWORK

(76) Inventor: Mingshen Gao, Batavia, IL (US)

Correspondence Address: DUFT BORNSEN & FISHMAN, LLP, 1526 SPRUCE STREET, SUITE 302, BOULDER, CO, 80302, US

(21) Appl. No.: 11/421,131

(22) Filed: May 31, 2006

(51) Int. Cl. H04Q 7/20

(52) U.S. Cl. 455/518

(57) ABSTRACT

Methods and systems for providing one-to-many communication services (e.g., push-to-talk (PTT)) using composite broadcast/multicast flows in a wireless network are disclosed. A permanent broadcast/multicast control flow is used to provide session control information (e.g., announcements for replacing the traditional paging and connection setup) and OAM messages to the subscribers of the one-to-many communication service. If a request for a communication session to a group of subscribers is initiated in the wireless network, then one or more broadcast/multicast content flows are established in the wireless network to the subscribers in the group. The broadcast/multicast content flows are used to provide signaling for the session, the audio for the session, or other media type of content for the session to the subscribers in the group.

### BACKGROUND OF THE INVENTION

1. Field of the Invention

The invention is related to the field of communications, and in particular, to providing a real-time one-to-many communication service using composite broadcast/multicast flows in a wireless network to subscribers using mobile devices.

2. Statement of the Problem

Wireless service providers continue to offer improved services to current and potential customers that enhance the wireless communication experience. One example of such services is push-to-talk (PTT) services. PTT is a two-way communication service that operates like a “walkie-talkie”. A normal cell phone call is full-duplex meaning that both parties can hear each other at the same time. PTT is half-duplex meaning that communication can only travel in one direction at any given moment. PTT services allow a PTT subscriber to instantly reach others defined in a talkgroup of the subscriber by eliminating the dialing and ringing steps in a regular cellular call. The PTT subscriber initiates a call by pressing a button on his/her PTT-enabled mobile phone. The call is received by a PTT server in the wireless network. The PTT server identifies the members of the talkgroup and establishes a communication channel to the mobile phone of each member of the talkgroup. The PTT server then provides call announcements to the members' mobile phones, receives acknowledgements from the members' mobile phones, and exchanges other messages with the members' mobile phones to connect the PTT call. When the call is connected, the initiating PTT subscriber can begin speaking. The PTT server will then transmit the originating subscriber's (or speaker's) voice to the other talkgroup members over the established communication channels.

One problem with present PTT networks is that network resources may be inefficiently used for PTT calls when a talkgroup has multiple members served by a single base station (in a worse case, a PTT call may not even be possible if the talkgroup has large number of concentrated members due to resources limitation), which is illustrated in FIG. 1. FIG. 1 illustrates a wireless network 102 adapted to provide PTT service in the prior art. Wireless network 102 includes a PTT server 104, a radio network controller (RNC) 112, and a base station 124. PTT server 104 connects to RNC 112 over any desired transport network 140. RNC 112 connects to base station 124 over a back haul network 142. Base station 124 provides a service area in which mobile phones 132-135 can communicate with wireless network 102 over the air interface 144 via wireless signals. Because base station 124 serves mobile phones 132-135, it can be assumed that mobile phones 132-135 are in the same geographic area.

Assume that mobile phone 136 initiates a PTT call to a talkgroup that includes mobile phones 132-135. PTT server 104 receives the call and identifies the members of the talkgroup. In an attempt to connect the PTT call to mobile phones 132-135, PTT server 104 establishes a communication channel to each mobile phone 132-135. Thus, for the four mobile phones 132-135 there are four communication channels established over the transport network 140, over the back haul network 142, and over the air interface 144 for the call. When the PTT call is established, PTT server 104 receives the content for the call (i.e., the voice of the subscriber using mobile phone 136) from mobile phone 136. PTT server 104 then transmits the same copy of the content over each of the communication channels for receipt by mobile phones 132-135. As a result, four copies of the content are transmitted over transport network 140, four copies of the content are transmitted over the back haul network 142, and four copies of the content are transmitted over the air interface 144.

Providing a PTT call as described above can be inefficient. First, multiple communication channels need to be established to provide the PTT call. The air interface 144 and the back haul network 142 have a limited bandwidth that is valuable to the service provider. Thus, establishing four substantially identical communication channels to mobile phones in the same geographic area is not an efficient use of network resources. Also, the content being transmitted over the communication channels is the same (i.e., the voice of the caller). Thus, it is inefficient use of network resources to transmit four separate copies of the content to mobile phones in the same geographic area. The inefficient use of system resources (RF and backhaul) will also impact other services, as resources consumed by one will reduce the usage for others.

It may be desirable to more efficiently use network resources for PTT services and other types of services that provide one-to-many communications to subscribers. Also in PTT service, it is desirable to setup a PTT call as fast as possible by reducing the session setup time.

### SUMMARY OF THE SOLUTION

The invention solves the above and other problems by providing a one-to-many communication service (e.g., a PTT service) in a wireless network using composite broadcast/multicast flows. A broadcast/multicast flow comprises any stream of information or data transmitted over the wireless network simultaneously to two or more receiving devices. Examples of a broadcast/multicast flow include a Broadcast and Multicast Services (BCMCS) flow or multicast IP flow. A permanent broadcast/multimedia flow, referred to as the control flow, may be established to subscribers in order to transmit session control information (e.g., announcements for bypassing the traditional paging and connection setup) and OAM messages to subscribers of the one-to-many communication service. One or more temporary broadcast/multimedia flows, referred to as content flows, may be established for each particular one-to-many communication session to provide the actual content for the session to the subscribers, such as signaling for the session, audio for the session, etc. These content flows are independent broadcast/multicast flows between the sessions and from the control flow. Together, these composite broadcast/multicast flows are used to provide various efficient one-to-many communication services.

By using broadcast/multicast flows for one-to-many communication sessions, network resources may advantageously be used more efficiently. Multiple individual communication channels do not need to be established to devices located in the same geographic area. Session setup information, content, etc, may be transmitted over the broadcast/multicast flows instead of over multiple individual channels, which can significantly reduce the network resource usage. Also, bandwidth usage over the back haul networks and air interfaces can advantageously be reduced as multiple copies of the same content do not need to be transmitted over the back haul networks or the air interfaces. For instance, a base station can broadcast a single copy of the content to multiple devices in the service area, which can dramatically reduce bandwidth usage over the air interface. In addition, the broadcast/multicast flows can also be used to reduce session setup time, which is valuable for one-to-many communication sessions.

One embodiment of the invention comprises a method of providing a one-to-many communication service (e.g., PTT service) in a wireless network. One step of the method includes establishing a broadcast/multicast control flow in the wireless network to subscribers of the one-to-many communication service. The broadcast/multicast control flow is used to provide session control information (including other servicing network locally-generated session setup related information) and OAM messages to subscribers of the service. The devices of the subscribers are adapted to monitor the broadcast/multicast control flow.

Assume that a subscriber transmits a request for a communication session (e.g., a call) to a group of subscribers. Responsive to the request, another step of the method includes transmitting session control information for the communication session to the subscribers in the group over the broadcast/multicast control flow. The session control information may include an announcement, an indication of the physical channels used for the broadcast/multicast content flows, etc. Another step of the method includes establishing one or more broadcast/multimedia content flows (temporary for the session when the session is the active) in the wireless network to the subscribers in the group. Another step of the method includes transmitting the content for the communication session (e.g., voice for a call) over the broadcast/multimedia content flows to the subscribers in the group. The devices of the subscribers in the group may then monitor the broadcast/multimedia content flows to receive the content for the communication session.

The invention may include these and other exemplary embodiments described below.

### DESCRIPTION OF THE DRAWINGS

The same reference number represents the same element or same type of element on all drawings.

FIG. 1 illustrates a wireless network adapted to provide a PTT service in the prior art.

FIG. 2 illustrates a wireless network adapted to provide a one-to-many communication service in an exemplary embodiment of the invention.

FIG. 3 is a flow chart illustrating a method of operating a wireless network to provide a one-to-many communication service in an exemplary embodiment of the invention.

FIG. 4 illustrates a wireless network providing a one-to-many communication service in an exemplary embodiment of the invention.

FIG. 5 illustrates a wireless network providing a one-to-many communication service in an exemplary embodiment of the invention.

FIG. 6 illustrates another wireless network adapted to provide a push-to-talk (PTT) service in an exemplary embodiment of the invention.

FIG. 7 is a message diagram illustrating a PTT call in a wireless network in an exemplary embodiment of the invention.

FIG. 8 is a flow chart illustrating another method of providing the one-to-many communication service using broadcast/multicast flows in an exemplary embodiment of the invention.

### DETAILED DESCRIPTION OF THE INVENTION

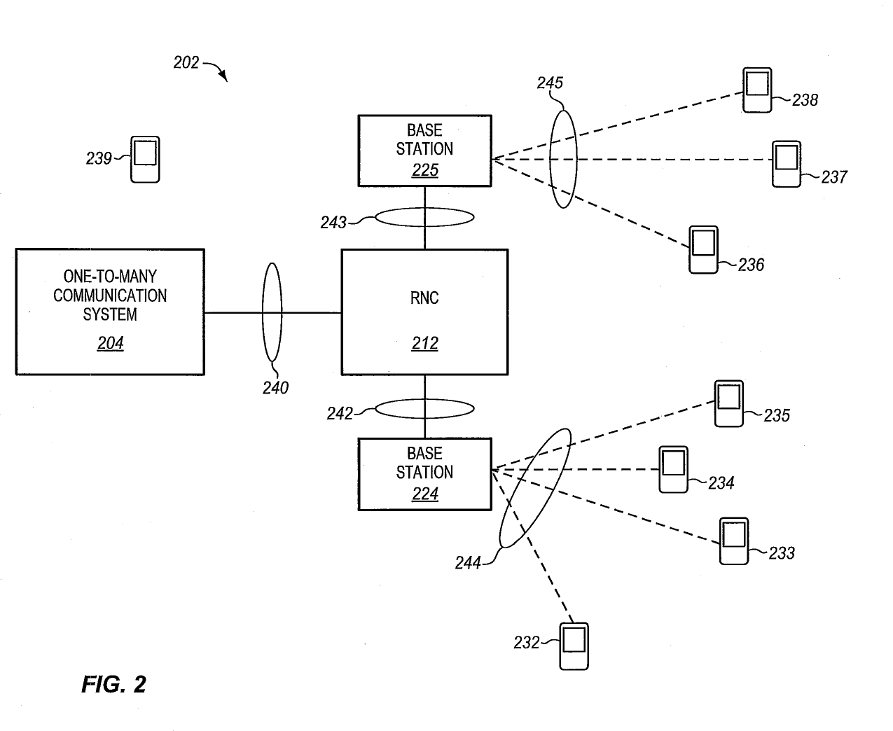

FIGS. 2-8 and the following descriptions depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below may be combined in various ways to form multiple variations of the invention. As a result, the invention is not limited to the specific embodiments described below, but only by the claims and their equivalents.

FIG. 2 illustrates a wireless network 202 adapted to provide a one-to-many communication service in an exemplary embodiment of the invention. Wireless network 202 includes a one-to-many communication system 204, one or more radio network controllers (RNC) 212, and base stations 224-225. One-to-many communication system 204 is coupled to RNC 212 over a transport network 240, such as a circuit-based network, an IP network, etc. RNC 212 is coupled to base stations 224-225 over back haul networks 242-243, respectively. Base station 224 communicates with mobile devices 232-235 over air interface 244. Similarly, base station 225 communicates with mobile devices 236-238 over air interface 245. Base stations 224-225 may communicate with mobile devices 232-235 and 236-238 respectively using CDMA, TDMA, GSM, or another wireless protocol compatible with mobile devices 232-238. Mobile devices 232-238 comprise any devices or systems configured to communicate via wireless signals, such as a cell phone, a PDA, etc. Wireless network 202 may include other radio network controllers, base stations, or other components or systems not shown in FIG. 2.

One-to-many communication system 204 is adapted to provide a one-to-many communication service to subscribers of the service. One example of a one-to-many communication service includes but is not limited to push-to-talk (PTT) service.

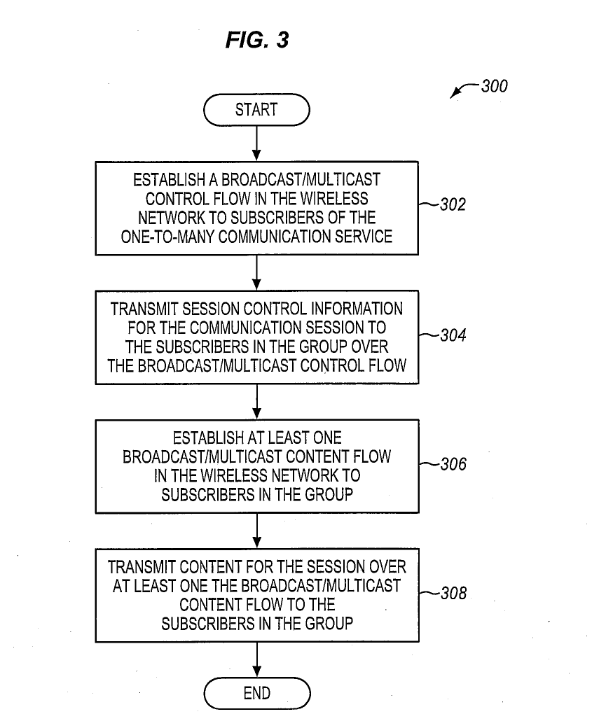

FIG. 3 is a flow chart illustrating a method 300 of providing the one-to-many communication service using broadcast/multicast flows in an exemplary embodiment of the invention. The steps of method 300 will be described with reference to wireless network 202 as illustrated in FIGS. 2, 4, and 5. The steps of the flow chart in FIG. 3 are not all inclusive and may include other steps not shown.

In step 302, one-to-many communication system 204 establishes a broadcast/multicast control flow in the wireless network 202 to subscribers of the one-to-many communication service. A broadcast/multicast control flow comprises any stream of information or data transmitted over wireless network 202 simultaneously to two or more receiving devices wherein the stream of information or data includes session control information, such as information used in setting up a one-to-many communication session (i.e., a one-to-many PTT call). Examples of a broadcast/multicast control flow include a Broadcast and Multicast Services (BCMCS) flow or multicast IP flow. Establishing a broadcast/multicast control flow to subscribers in this embodiment may mean establishing a multicast flow from one-to-many communication system 204 to RNC 212 and other RNCs not shown in FIG. 2, establishing a broadcast/multicast flow (which may actually be a bearer path to the broadcast channel at the sector within the RNC for carrying the broadcast/multicast flow) from RNC 212 to base stations 224-225 (and possibly other base stations), and establishing a broadcast flow (it is the RNC specified physical broadcast channel at the sector) from base stations 224-225 to the mobile devices of the subscribers.

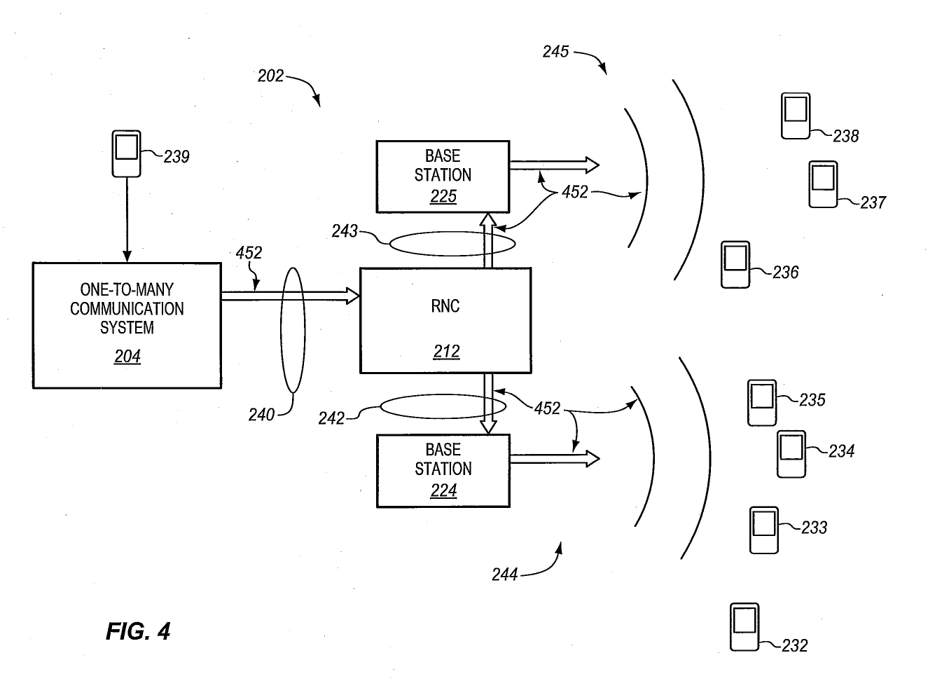

FIG. 4 illustrates wireless network 202 with the broadcast/multicast control flow 452 established. Broadcast/multicast control flow 452 is established to each or substantially each of the subscribers of the one-to-many communication service. The mobile devices of the subscribers, such as mobile devices 232-238, are adapted to monitor the broadcast/multicast control flow 452 for announcements, OAM messages, etc, similar to how they are adapted to monitor the normal control channel for paging messages. To establish the broadcast/multicast control flow 452, one-to-many communication system 204 establishes the broadcast/multicast control flow 452 over one or more communication channels over transport network 240 to RNC 212. One-to-many communication system 204 establishes the broadcast/multicast control flow 452 over one or more communication channels over back haul networks 242-243 between RNC 212 and base stations 224-225. One-to-many communication system 204 also establishes the broadcast/multicast control flow 452 over air interfaces 244-245 from base stations 224-225 using one or more broadcast communication channels. Base stations 224-225 broadcast the broadcast/multicast control flow 452 over the broadcasting channels to mobile devices 232-238. A communication channel in this embodiment may comprise port/flow numbers for identifying the broadcast/multicast control flow within the RNC or time slots for identifying physical broadcasting channels at sectors. The communication channels are virtual in the sense that they do not take away any actual bandwidth until there is real data/messages that are passing through them. Although base stations 224-225 may broadcast at the sector level, FIG. 4 shows just a general broadcast for illustrative purposes.

Assume that a subscriber of the one-to-many communication service using mobile device 239 initiates a one-to-many communication session to a group of subscribers (i.e., a talkgroup) using mobile devices 232-235. One-to-many communication system 204 receives a request for the communication session from mobile device 239. In step 304 of method 300 shown in FIG. 3, one-to-many communication system 204 transmits session control information for the communication session to the subscribers in the group over the broadcast/multicast control flow 452 illustrated in FIG. 4. The session control information may include an announcement, a group ID for the present session, session priority, or other information.

In step 306 of FIG. 3, one-to-many communication system 204 establishes at least one broadcast/multicast content flow in the wireless network 202 to the subscribers in the group. A broadcast/multicast content flow comprises any stream of information or data transmitted over wireless network 202 simultaneously to two or more receiving devices wherein the stream of information or data includes content for a communication session, such as signaling for the session, audio for the session, etc.

Multiple broadcast/multicast content flows may be needed for the session. For instance, one broadcast/multicast content flow may be needed for signaling for the session, such as to broadcast the name/number for the requesting subscriber. Another broadcast/multicast content flow may be needed for the audio for the session (i.e., the voice of the requesting subscriber). Another broadcast/multicast content flow may be needed for video for the session (if wireless network 202 is enabled for video). The one-to-many communication service establishes one or more broadcast/multicast content flows to the subscribers of the group as needed for the session. The broadcast/multicast content flows are temporary in nature, meaning that one-to-many communication service establishes the content flows for the duration of the present session.

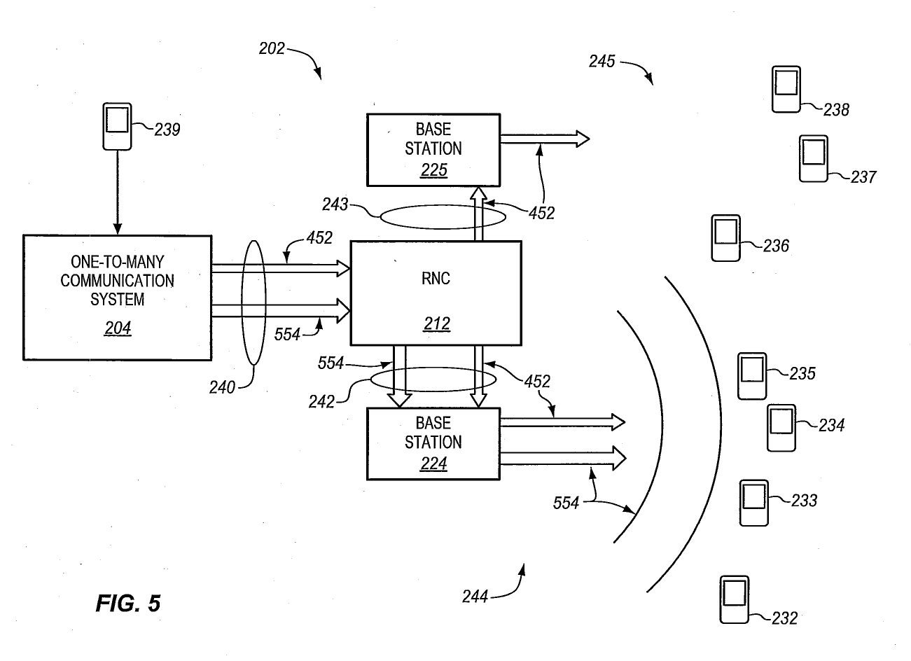

FIG. 5 illustrates wireless network 202 with one or more broadcast/multicast content flows 554 established for the session. Broadcast/multicast control flows 554 are established to each of the subscribers that are members of the group for this particular session. To establish the broadcast/multicast content flow 554, one-to-many communication system 204 establishes the broadcast/multicast content flow 554 over one or more communication channels over transport network 240 to RNC 212. One-to-many communication system 204 also establishes the broadcast/multicast content flow 554 over one or more communication channels over back haul network 242 between RNC 212 and base station 224. One-to-many communication system 204 also establishes a broadcast channel for broadcasting the broadcast/multicast content flow 554 over air interface 244 from base station 224 to mobile devices 232-235. Although base station 224 may broadcast at the sector level, FIG. 5 shows just a general broadcast for illustrative purposes.

In step 308 of method 300 shown in FIG. 3, one-to-many communication system 204 transmits content for the communication session over the broadcast/multicast content flows 554 to the subscribers in the group illustrated in FIG. 5. The content for the session may include signaling for the session, audio for the session, video for the session, or other content.

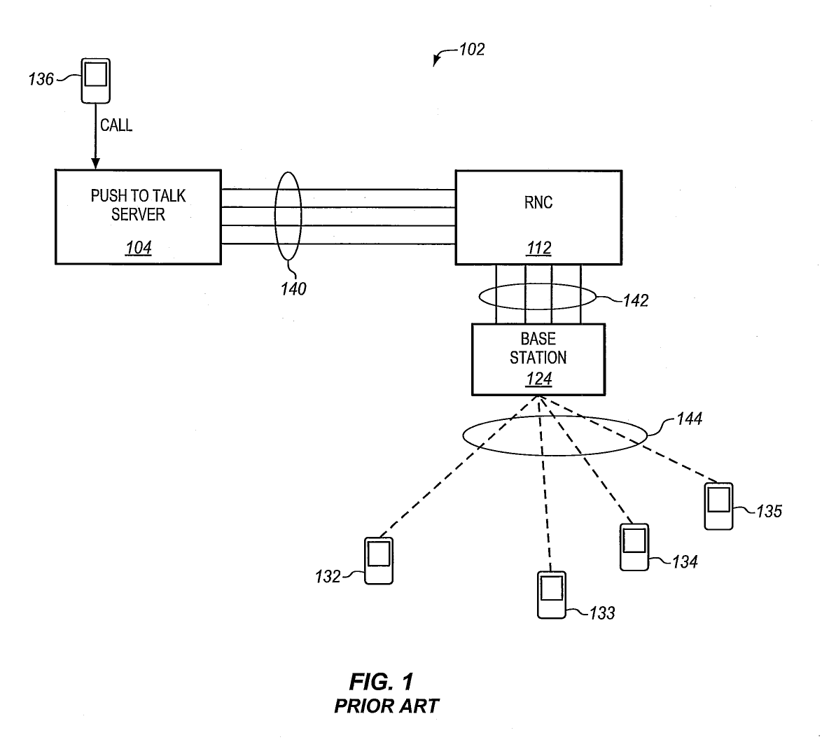

By using the broadcast/multicast flows, one-to-many communication system 204 can transmit session control information and content to a plurality of mobile devices 232-235 in a more efficient manner. As is evident in FIG. 5, one-to-many communication system 204 may transmit a single copy of the session control information over broadcast/multicast control flow 452 to RNC 212 and base station 224. Base station 224 may then broadcast a single copy of the session control information (one copy per sector for sectors populated with recipients) over the air interface 244 to mobile devices 232-235. Also, one-to-many communication system 204 may transmit a single copy of the content over broadcast/multicast content flows 554 to RNC 212 and base station 224. Base station 224 may then broadcast a single copy of the content (one copy per sector for sectors populated with recipients) over the air interface 244 to mobile devices 232-235. Base station 224 does not have to establish four individual communication channels with mobile devices 232-235 and then transmit multiple copies of the same session control information or the same content to each mobile device 232-235 over the individual communication channels as is done in conventional PTT networks as in FIG. 1. Network resources are more efficiently used and bandwidth is advantageously saved over air interface 244 and back haul network 242, which are the most critical (expensive and limited) system resources.

As eluded to above, one-to-many communication system 204 may establish the broadcast/multicast control flow 452 and the broadcast/multicast content flows 554 at the sector level in base stations 224-225. One-to-many communication system 204 may generate a distribution table for each group of subscribers that identifies each sector that is presently serving members of the group. Mobile devices 232-235 are adapted to register with the broadcast/multicast control flow at RNC 212 and/or one-to-many communication system 204 and thus provide their sector location. RNC 212 and one-to-many communication system 204 may use the sector information to generate the distribution tables for the groups of subscribers. If one of mobile devices 232-235 moves to different sectors, RNC 212 and one-to-many communication system 204 are adapted to identify the new sector and update the distribution tables accordingly.

In another embodiment of the invention, broadcast/multicast content flows within RNC 212 may be established to subscribers depending on the number of subscribers in a given sector. If there are multiple subscribers in a sector, then broadcast/multicast content flows (which may actually be bearer paths for carrying the flow to broadcast channels) may be established from RNC 212 to the subscribers in that sector. If there is one (or a small number) of subscriber(s) in a sector, then individual traffic channels may be established from RNC 212 to the subscribers in that sector instead of broadcast/multicast content flows using broadcast channels. Based on the knowledge of the member distribution, RNC 212 can use the most efficient method to deliver the media content for the session to its recipients.

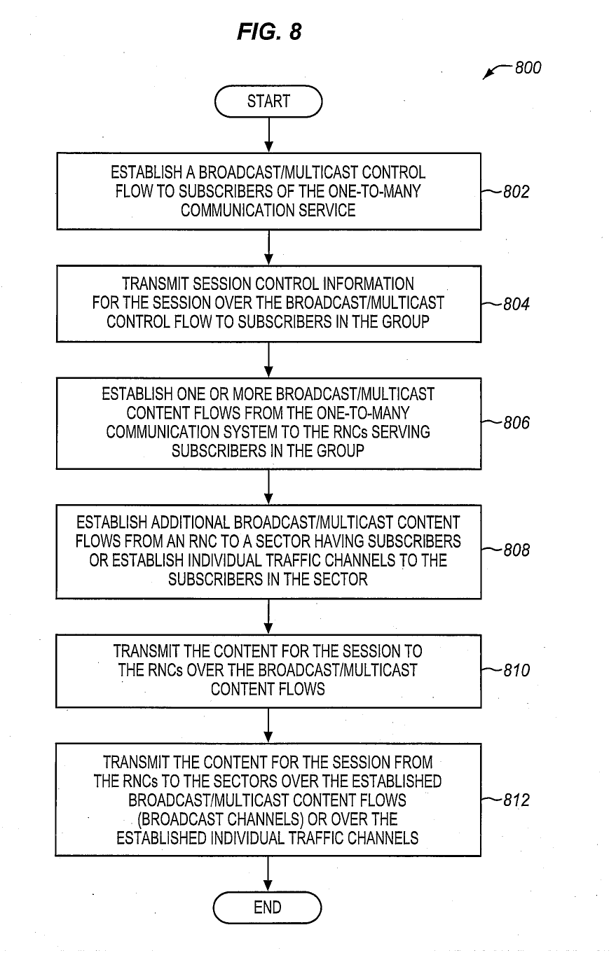

FIG. 8 is a flow chart illustrating another method 800 of providing the one-to-many communication service using broadcast/multicast flows in an exemplary embodiment of the invention. The steps of method 800 will be described with reference to wireless network 202 as illustrated in FIG. 2. The steps of the flow chart in FIG. 8 are not all inclusive and may include other steps not shown.

In step 802, one-to-many communication system 204 establishes a broadcast/multicast control flow in the wireless network 202 to subscribers of the one-to-many communication service as described in FIG. 3. Assume that a subscriber of the one-to-many communication service using mobile device 239 initiates a request for a communication session to a group of subscribers using mobile devices 232-235. One-to-many communication system 204 receives the request from mobile device 239. In step 804 of FIG. 8, one-to-many communication system 204 transmits session control information for the session to the subscribers in the group over the broadcast/multicast control flow. The session control information may include an announcement, a group ID for the present session, or other information. In step 806 of FIG. 8, one-to-many communication system 204 establishes one or more broadcast/multicast content flows to the RNC(s) 212 serving the subscribers of the group. One-to-many communication system 204 uses the distribution tables for the group to determine which RNCs 212 are serving subscribers in the group.

RNC 212 may serve one or more sectors having subscribers. Thus, RNC 212 may operate as follows for each of the sectors. In step 808 of FIG. 8, RNC 212 establishes one or more broadcast/multicast content flows (which may be bearer paths to broadcast channels for the broadcast/multicast content flow coming to the RNC) to the sector having subscribers in the group, or establishes individual traffic channels to the sector having subscribers based on the member distribution over the sector (i.e., the number of subscribers in the sector). For instance, if one (or a small number) of subscribers are in a sector, then RNC 212 may establish individual traffic channels to the mobile devices of the subscribers in that sector and unicast the content stream over the individual traffic channels. If multiple (or a large number) of subscribers are in the sector, then RNC 212 may establish a broadcast/multicast content flow to the sector, which broadcasts the content to the subscribers in the sector using the single broadcast channel for the content flow. RNC 212 uses the distribution tables for the group to determine how many subscribers are in a given sector.

In step 810 of FIG. 8, one-to-many communication system 204 transmits content for the session to RNC(s) 212 over the broadcast/multicast content flow to RNC(s) 212. In step 812 of FIG. 8, RNC 212 transmits content for the session to the sector over the established communication channels (i.e., broadcast channels or unicast channels). The content for the session may include signaling for the session, audio for the session, video for the session, or other content.

### EXAMPLE

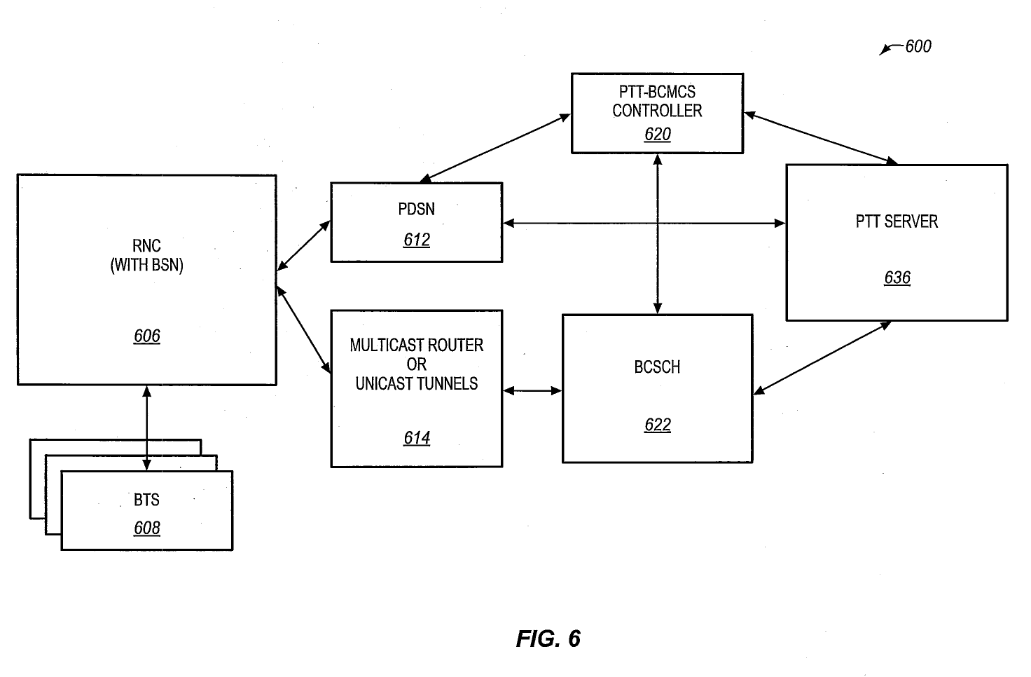

FIG. 6 illustrates another wireless network 600 adapted to provide a push-to-talk (PTT) service in an exemplary embodiment of the invention. Wireless network 600 is a third-generation cdma2000 (1×EV-DO/HRPD) wireless IP network in this embodiment, but could comprise another wireless network in other embodiments. The PTT service in wireless network 600 is enhanced with broadcast and multicast services (BCMCS) capability. Thus, wireless network 600 may be referred as a PTT-BCMCS servicing network. BCMCS is a service that provides point-to-multipoint transmission of multimedia data (e.g., text, audio, pictures, video, etc) from a single source point to all users or a group of users. BCMSC is typically used to broadcast content, such as news, stock reports, sporting events, etc, from a content server to a plurality of subscribers. In this embodiment, the concept of broadcasting content using BCMCS is extended to PTT service for transporting the potentially large number of contents as well as the associated session control information for large number of simultaneous active group calls to enhance the PTT service. The content for each active group call session in this embodiment is the audio (i.e., voice) and signaling for the PTT call that is broadcast to the other PTT subscribers. BCMCS has mechanisms that allow the PTT call content to be efficiently transmitted to multiple called subscribers.

Wireless network 600 includes PTT server 636, PTT-BCMCS controller 620, PTT-BCMCS content server with group call handler (BCSCH) 622, packet data serving node (PDSN) 612, multicast router or unicast tunnel 614, a radio network controller (RNC) 606 that is enhanced with a Broadcast Servicing Node (BSN) function, and base transceiver stations (BTS) 608. According to features and aspects herein, a composite BCMCS model is used for PTT calls to provide an integrated PTT-BCMCS service. The composite BCMCS model includes a dedicated BCMCS control flow that is available to all or substantially all of the PTT subscribers to assist in setting up PTT calls. The composite BCMCS model also includes a plurality of BCMCS sub-programs that are mapped to individual talkgroups established by the PTT subscribers. The BCMCS sub-programs provide BCMCS content flows that are used to broadcast content for the PTT calls (i.e., in-call signaling and audio) to the members of a talkgroup. The BCMCS sub-programs are related to the dedicated BCMCS control flow, but are independent of each other as the talkgroups are independent. The dedicated BCMCS control flow and its associated BCMCS sub-programs together define the PTT-BCMCS service. Two goals of the PTT-BCMCS service are to provide faster call setup times, which is important in measuring PTT service performance, and to make more efficient use of critical network resources (backhaul and air interface), which helps to serve more users.

For the combined PTT-BCMCS service, the PTT subscribers first set up talkgroups. Each PTT subscriber creates talkgroups that are registered with PTT-BCMCS controller 620. PTT-BCMCS controller 620 assigns a talkgroup ID to each talkgroup, and assigns BCMCS content flow IDs to each talkgroup according to the mapping of the BCMCS (sub)program for the talkgroup. On initial registration of the subscribers with PTT-BCMCS controller 620, PTT-BCMCS controller 620 notifies the access terminal (AT) of each subscriber of the talkgroups that the subscriber is a member. The AT may perform BCMCS information acquisition for its BCMCS talkgroups from the PTT-BCMCS controller 620 through XML messages or other messages. This acquisition may give the AT information on the BCMCS talkgroup, such as the BAK (if needed). The AT then locally configures each talkgroup, including the associated flow IDs for the talkgroups, based on information provided by PTT-BCMCS controller 620. If talkgroups are changed or added, PTT-BCMCS controller 620 notifies the ATs through operational, administration and maintenance (OAM) messages over the dedicated BCMCS control flow so that the ATs can update their local configurations. PTT-BCMCS controller 620 may use the dedicated BCMCS control flow to notify all members of a talkgroup about OAM activities (such BAK changes) that impact the talkgroup.

The PTT-BCMCS servicing network 600 also generates member distribution tables for each talkgroup. The distribution tables maintained by the RNCs 606 indicate sectors in wireless network 600 having targets (i.e., subscribers) in a talkgroup. If unicast tunnels are used instead of the multicast IP, BCSCH 622 will also maintain distribution tables for RNCs having members for a talkgroup. The distribution tables are used to establish broadcast paths for both the BCMCS control flow and BCMCS content flows when a PTT call is being set up.

Unlike traditional BCMCS, such as the broadcast of a sporting event, where subscribers actively request for the delivery of BCMCS content streams based on fixed time schedule with a specified time-window for registration, the PTT service subscribers may not actively request to receive a particular BCMCS flow. They are passive parties, meaning that they are typically being notified about an incoming call and the BCMCS content for a talkgroup is generally unavailable (only valid spontaneously in a short while when the group is being called). Due to the passive involvement of the subscribers, PTT-BCMCS servicing network 600 needs to know where the subscribers are located by establishing the distribution tables for talkgroups so that it can notify the members about the calls and setup BCMCS content flows to deliver the content for calls in real time (right at the time when a call is being setup).

Part of the BCMCS control protocol for dynamic BCMCS registration (which is at the top of Application Layer for CDMA air interface protocol suite) could be generally used for establishing a subscriber (member) distribution table for a BCMCS program/flow in the servicing network, as specified by the 3GPP2 BCMCS standard for bearer establishment. The PTT-BCMCS servicing network 600 makes use of the BCMSC registration as follows.

In the BCMCS standard, a BCMCS program/flow has a fixed schedule and a specified time window for registration. The servicing network sets up the bearers for delivering the program/flow based on the registration in the time window right before the scheduled broadcasting/multicasting for the content stream. The distribution (for the registration request) is managed at different levels: the AN/PCF keeps the list of sectors/ANs having subscribers and the BSN maintains the list of PCFs having subscribers for the program/flow. However, the BCMCS flows associated with a PTT call are spontaneous with no fixed schedule and there is no time window for waiting to setup bearers while the call is being setup (the targets of a PTT call need to learn about the incoming BCMCS flows in real time). Also, each subscriber could often be in multiple talkgroups.

Because the PTT-BCMCS servicing network 600 uses the permanent PTT-BCMCS control flow to pass call announcements and other information to members of talkgroups continuously, it will establish distribution tables for the talkgroups based on BCMCS registration for the single dedicated BCMCS control flow. On a subscriber's first registration to the control flow, the network elements (RNCs 606 and BCSCH 622) will acquire information for all talkgroups having the subscriber as member from the PTT-BCMCS controller 620. The network elements will also authenticate the subscriber, verify the signature in the registration to ensure that the subscriber has the proper BAK sequence, etc. Based on the periodic BCMCS registration from the subscriber including exceptional BCMCS registration for moving across sectors, as specified by the standard, they will update the distribution tables for talkgroups correspondingly. The RNCs 606 will maintain list of sectors having members for a talkgroup. The BCSCH 622 will either use multicast IP for broadcasting/multicasting to RNCs 606 or create/maintain a list of RNCs having members for a talkgroup for establishing unicast tunnels between RNCs 606 and BCSCH 622, as both are mechanisms for BCMCS flow bearers specified by the standard.

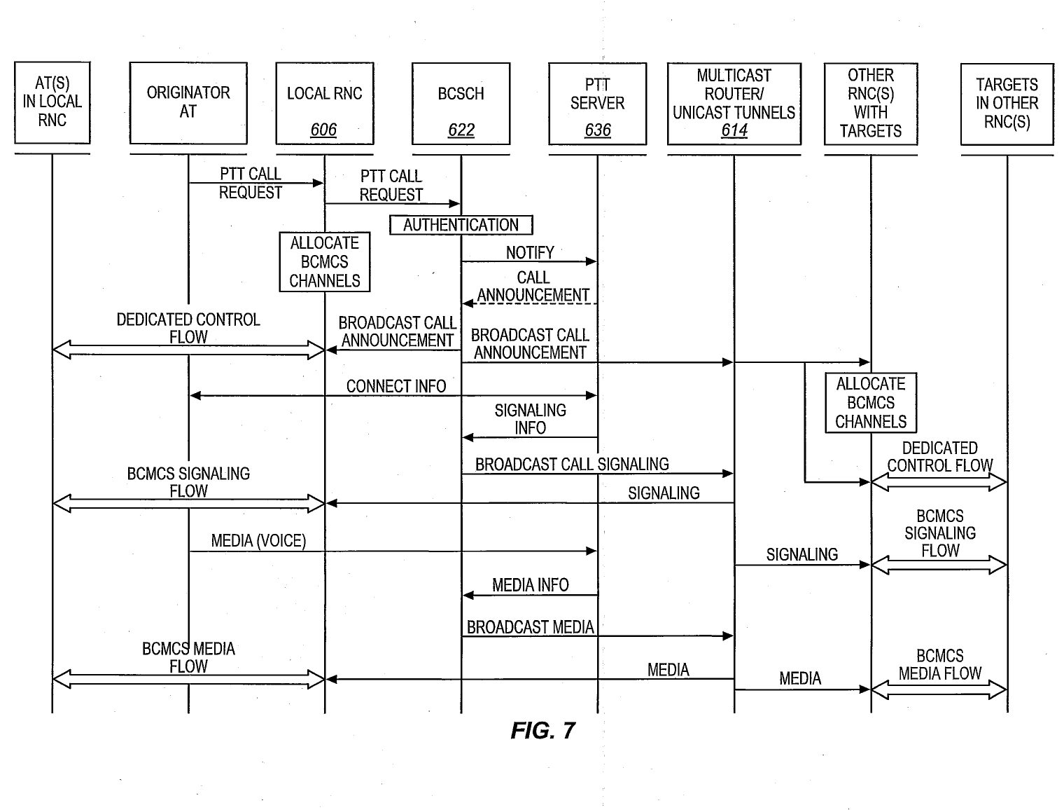

Assume for this embodiment that a subscriber to the PTT-BCMCS service wants to initiate a PTT call to a plurality of members of a talkgroup. FIG. 7 is a message diagram illustrating a PTT call in wireless network 600 in an exemplary embodiment of the invention. To initiate a PTT call, the originating AT of the subscriber transmits a PTT call request to RNC 606. The PTT call request comprises a BCMCS registration message to the BCMCS sub-program of the talkgroup. The originating AT transmits the BCMCS registration message over an access channel (assuming the typical case of no traffic channel), which provides advantages for reducing call setup time. This is due to two factors. First, it saves traffic channel request/assign/acquisition time as the originating AT would have to go through this phase first before it can transmit the call request to the PTT server in a traditional PTT call. Second, the servicing network could start to notify members of the talkgroup right way which saves transport delay and PTT server processing delay. Responsive to the BCMSC registration message, while using the fast connection setup procedure to assign a traffic channel to the originating AT, RNC 606 identifies a local distribution table for the talkgroup and allocates BCMCS channels for sectors having targets of the talkgroup. RNC 606 also forwards the BCMCS registration message to BCSCH 622. BCSCH 622 authenticates the PTT call to the talkgroup and notifies PTT server 636 of the PTT call.

BCSCH 622 then provides a call announcement to the members of the talkgroup over the BCMCS control flow through multicast router or unicast tunnels element 614. Providing the call announcement over the BCMCS control flow provides advantages over traditional PTT call announcements. In traditional PTT calls, the call announcements are transmitted to individual targets in a unicast manner. A target is first notified through a page message transmitted in a synchronous capsule over a control channel defined for the cdma200 EV-DO air interface. Responsive to the page, a targeted (being called) AT requests and is assigned with a traffic channel in order to receive the call announcement assuming that the admission control has been successful for the AT. By using the BCMCS control flow as described herein, the call announcement is broadcast directly to all the targets in a sector at the same time which uses network resources more efficiently and saves bandwidth on the air interface. Because the call's content will be delivered in BCMCS physical channels, the traffic channels for recipients are simply wasted after passing call announcement. Also, call announcements can be provided faster using the BCMCS control flow. First, the process of sending a page and setting up a traffic channel for the call announcement is eliminated, which often consumes a significant part of the call setup time. Second, the BCMCS channel assigned for the dedicated BCMCS control flow is faster than a control channel used for paging. Control channels typically have transfer rates of 19 kbps, 38 kbps, or 76.8 kbps while the BCMCS channel may be as high as 614 kbps. Third, the synchronous capsule used for the page message has a cycle time of 256 slots, while the BCMCS control flow has a much smaller cycle, such as 64 slots. Providing the call announcement as described above can further reduce call setup time significantly.

BCSCH 622 establishes the BCMCS content flows for the PTT call. The content (signaling and audio) are provided by the PTT server 636 acting as the BCMCS content provider as discussed in the next paragraph. The BCMCS content flows are established to the sectors of wireless network 600 having targets for the talkgroup. A BCMCS content flow is established for the in-call signaling for the call (BCMCS signaling content flow), and a BCMCS content flow is established for the audio (i.e., voice) for the call (BCMCS media content flow). Another BCMCS content flow may be established for video for the call if wireless network 600 and the ATs are provisioned accordingly. The BCMCS content flows are broadcast to targets over BCMCS physical channels. Information on the physical channels needs to be provided to the members' ATs of the talkgroup so that the ATs know which channels to monitor in order to receive the content streams. In traditional BCMCS, the channel information is provided in Broadcast Overhead Messages (BOM) that are transmitted over a control channel (just as the paging messages were provided). According to features and aspects herein, RNC 606 (and other RNCs with targets) may combine the call announcement and a simplified BOM that includes BCMCS information for the call's content flows as a single message that is transmitted to the ATs over the BCMCS control flow. Providing the combined call announcement and BOM message over the BCMCS control flow is faster and more efficient than transmitting the BOM message alone over a control channel.

Responsive to receiving the notification of the PTT call from BCSCH 622, PTT server 636 may optionally return a call announcement to authorize the call (BCSCH 622 could have done this already), and starts to set up the call by selecting host for the call. The PTT server 636 communicates with the originator for setting up connection to receive the media for the call (the originator may also pass more parameters for the call request once the connection is up). The PTT server 636 passes the call related information (such as the host information) as signaling content to the BCSCH 622 for constructing the BCMCS signaling content flow. For optimistic talk permit, the floor grant to the originator can be put into the first call announcement so that the originator can start to speak (the voice will be buffered until the connection to the PTT server is up). PTT server 636 may require acknowledgements from the member of the talkgroup responsive to the call announcement (also referred to as guaranteed talk permit). Guaranteed talk permit has traditionally caused problems as every single one of the targets need to request a traffic channel in order to send an acknowledgement back to PTT server 636. According to features and aspects here, the targets do not need to request a traffic channel in order to send an acknowledgement to PTT server 636. A target may transmit a BCMCS registration message for the BCMCS sub-program assigned to the talkgroup to the servicing network 600. This registration acts as an acknowledgement from the AT. With the BCMCS content flows established, BCSCH 622 broadcasts in-call signaling to the RNCs 606 having targets over the BCMCS signaling content flow. The RNCs 606 then broadcast the in-call signaling to the sectors having targets over the BCMCS signaling content flow.

PTT server 636 then receives media (i.e., voice) for the call from the originating AT. PTT server 636 forwards the media stream to BCSCH 622 for constructing the BCMCS media content flow. BCSCH 622 may manipulate/reformat the media stream such as to provide any required encryption. BCSCH 622 then broadcasts the media stream to the RNCs 606 having targets over the BCMCS media content flow. The RNCs 606 then broadcast the media stream to the sectors having targets over the BCMCS media content flow. By broadcasting the media for the call, only one copy of the media needs to be transmitted to an RNC and only one copy of the media needs to be transmitted to a sector. For a talkgroup that has multiple targets in a sector, the BCMCS media content flow advantageously saves bandwidth for both the limited and expensive air interface and backhaul which are typically the most valuable system resources owned by a service provider.

As illustrated in FIGS. 6-7, integrating PTT and BCMCS as described herein provides many advantages. The integrated PTT-BCMCS service allows for faster call setup times, which is advantageous for PTT calls. The integrated PTT-BCMCS service also uses network resources more efficiently by broadcasting information, which is especially advantageous when there are a large number of subscribers in the same service area.

Although specific embodiments were described herein, the scope of the invention is not limited to those specific embodiments. The scope of the invention is defined by the following claims and any equivalents thereof.

I claim:

1. A method of using composite broadcast/multicast flows to provide a one-to-many communication service in a wireless network, the method comprising:
establishing a broadcast/multicast control flow in the wireless network to subscribers of the one-to-many communication service;
responsive to receiving a request for a communication session in the wireless network to a group of subscribers of the one-to-many communication service, transmitting session control information for the communication session to the subscribers in the group over the broadcast/multicast control flow;
establishing at least one broadcast/multicast content flow in the wireless network to the subscribers in the group; and
transmitting content for the communication session over the at least one broadcast/multicast content flow to the subscribers in the talkgroup.

2. The method of claim 1 wherein transmitting session control information for the communication session includes:
transmitting an announcement for the communication session over the broadcast/multicast control flow.

3. The method of claim 1 further comprising:
identifying RNCs and sectors corresponding with the locations of the subscribers in the group; and
establishing the at least one broadcast/multicast content flow to the identified sectors.

4. The method of claim 1 wherein the broadcast/multicast control flow and the at least one broadcast/multicast content flow comprise Broadcast and Multicast Service (BCMCS) flows.

5. The method of claim 1 wherein the one-to-many communication service comprises a push-to-talk (PTT) service.

6. The method of claim 1 wherein the content for the communication session comprises at least one of audio and signaling.

7. The method of claim 1 wherein the wireless network comprises a cdma2000 (1×EV-DO) wireless network.

8. A wireless network adapted to provide a one-to-many communication service using composite broadcast/multicast flows, the wireless network comprising:
a radio network controller (RNC) adapted to communicate with subscribers of the one-to-many communication service; and
a one-to-many communication system adapted to establish a broadcast/multicast control flow through the RNC to the subscribers, receive a request for a communication session to a group of subscribers of the one-to-many communication service, transmit session control information for the communication session to the subscribers in the group over the broadcast/multicast control flow, and establish at least one broadcast/multicast content flow to the RNC;
the RNC is further adapted to establish at least one additional broadcast/multicast content flow to a sector of the RNC having subscribers in the group or establish at least one individual traffic channel to the sector having the subscribers in the group based on the number of subscribers in the sector;
the one-to-many communication system is further adapted to transmit content for the communication session over the at least one broadcast/multicast content flow to the RNC;
the RNC is further adapted to transmit the content for the communication session over the at least one additional broadcast/multicast content flow established to the sector having subscribers in the group, or over the at least one individual traffic channel to the subscribers in the group.

9. The wireless network of claim 8 wherein the RNC is further adapted to maintain a distribution table for the group to determine the number of subscribers in the sector.

10. The wireless network of claim 8 wherein the session control information includes an announcement for the communication session.

11. The wireless network of claim 8 wherein the broadcast/multicast control flow and the at least one broadcast/multicast content flow comprise Broadcast and Multicast Service (BCMCS) flows.

12. The wireless network of claim 8 wherein the one-to-many communication service comprises a push-to-talk (PTT) service.

13. The wireless network of claim 8 wherein the content for the communication session comprises at least one of audio and signaling.

14. The wireless network of claim 8 wherein the wireless network comprises a cdma2000 (1×EV-DO) wireless network.

15. A method of providing an enhanced Push to Talk (PTT) service in a wireless network, the method comprising:
establishing a Broadcast and Multicast Service (BCMCS) control flow in the wireless network to subscribers of the PTT service wherein the BCMCS control flow is adapted to provide session control information to the subscribers;
maintaining distribution tables for talkgroups of the PTT service;
receiving a PTT call request in the wireless network to a talkgroup having a plurality of the subscribers;
establishing additional BCMCS content flows in the wireless network to the subscribers in the talkgroup responsive to the PTT call wherein the additional BCMCS content flows are adapted to provide PTT content for the PTT call to the subscribers in the talkgroup;
transmitting a call announcement to the subscribers in the talkgroup over the BCMCS control flow; and
transmitting content for the PTT call over the additional BCMCS content flows to the subscribers in the talkgroup.

16. The method of claim 15 wherein receiving a PTT call request to a talkgroup in the wireless network comprises:
receiving a BCMCS registration message to the at least one BCMCS content flow assigned to the talkgroup from an originating access terminal.

17. The method of claim 15 further comprising:
receiving BCMCS registration messages for the BCMCS control flow from the subscribers; and
generating distribution tables for talkgroups responsive to the registration messages, wherein a distribution table of a talkgroup indicates sectors within an RNC in the wireless network having subscribers of the talkgroup.

18. The method of claim 15 wherein transmitting a call announcement to the subscribers in the talkgroup over the BCMCS control flow comprises:
transmitting the call announcement including session related parameters and a BCMCS Broadcast Overhead Message including BCMCS content flow related parameters as a single message to the subscribers in the talkgroup over the BCMCS control flow.

19. The method of claim 15 wherein the content for the communication session comprises at least one of audio and signaling.

20. The method of claim 15 wherein the BCMCS control flow is permanently established for the PTT service, and the BCMCS content flows are dynamically established for the PTT call.
